(19) United States
(12) Patent Application Publication
(10) Pub. No.: US 2018/0223894 A1
(43) Pub. Date: Aug. 9, 2018

(54) JOINING COMPONENT AND METHOD FOR ITS PRODUCTION

(71) Applicant: NEWFREY LLC, New Britain, CT (US)

(72) Inventor: Sascha Gramsch-Kempkes, Giessen (DE)

(21) Appl. No.: 15/623,984

(22) Filed: Jun. 15, 2017

Related U.S. Application Data
(63) Continuation of application No. PCT/EP2015/071546, filed on Sep. 21, 2015.

(30) Foreign Application Priority Data
Dec. 18, 2014 (DE) 102014118973.6

(51) Int. Cl. F16B 37/04; F16B 11/00; B23K 15/00; B23K 26/21

(52) U.S. Cl. CPC F16B 37/048; B23K 26/21; B23K 15/0046; F16B 11/006

(57) ABSTRACT

The present invention relates to a joining component (10) with a joining surface (12) which has an application area (14) to which a joining material (16) is pre-applied and which can be later activated by means of heat treatment, wherein the application area (14) has a retentive surface structure with elevations (20) forming material undercuts (26), and the joining material (16) at least partially covers the application area (14) and is introduced into the material undercuts (26).

### CROSS-REFERENCE TO RELATED APPLICATIONS

This application is a continuation of international application PCT/EP2015/071546, filed Sep. 21, 2015 which claims priority from German Patent Application No. 102014118973.6 filed Dec. 18, 2014, the disclosures of which are incorporated herein by reference in their entirety.

### BACKGROUND OF THE INVENTION

The present invention relates to a joining component with a joining surface which has an application area onto which a joining material is pre-applied which can be activated by means of heat treatment.

Moreover, the present invention relates to a method for producing such a joining component.

In the engineering field of joining joining components or fastening elements to workpieces, one known practice is to weld metal studs onto metal workpieces, for example. This method, which is known as “stud welding”, is used especially in the automobile industry in order to weld studs to body panels, with fastening clips made of plastic subsequently being attached to the studs, and cables, lines etc. being fixed to said clips.

Another known practice is to weld such fastening elements made of plastic to plastic workpieces by thermoplastic processes.

Finally, there is a known practice of adhesively bonding joining components in the form of such fastening elements to workpieces. Especially due to the fact that in motor vehicle body assembly non-metallic composite materials, such as plastics, fibre composite components, etc., are increasingly being used, the adhesive bonding technique has been established as a fastening method, especially in body assembly.

It is generally known in this case to apply an adhesive to a joining surface of a joining component, wherein the adhesive is usually applied in a heated state and then cooled again. The thus produced component with applied adhesive is then supposedly capable of being transported, e.g. from a production point to a location at which the joining component is to be adhesively bonded to the workpiece.

During the actual adhesive bonding process, the adhesive is then activated or reactivated, wherein the adhesive is usually heated again. The adhesives used for this are designed to crosslink within a relatively short time during the adhesive bonding process so that an adhesive bond can be realized within time intervals of less than 60 s, in particular less than 30 s, preferably less than 10 s.

In motor vehicle body assembly, a multiplicity of such joining components in the form of fastening elements are generally adhesively bonded to body sections. This is usually carried out by automated, robot-assisted adhesive bonding systems in which the joining components are fed automatically.

Similarly, this frequently also takes place in the case of joining components or fastening elements which are attached and fastened on the workpiece with the aid of other joining techniques (e.g. welding or soldering). In this case also, it is often desirable to already apply in advance the joining material to a joining surface of the joining component provided for it so that the same problem of a good transportability of the joining component together with pre-applied joining material ensues.

Joining components or fastening elements, such as adhesive studs, weld studs or rivets, are in most cases transported to the end manufacturer as loose material. As a result of the pre-application of the joining material before the transporting, the process step of “applying the joining material “in the facility of the end manufacturer can be dispensed with so that a saving can be made in process time and process cost in this. To this end, it is necessary, however, that during the transporting and handling of the joining components the pre-applied joining material remains in a true position upon these. Therefore, for example during delivery of adhesive studs as loose material, the mechanical load during the transporting and during the feeding of the adhesive studs onto the workpiece can lead to exfoliation of the pre-applied adhesive. Therefore, a sufficient retention force of the pre-applied adhesive or other joining material is to be ensured until the adhesive or the other joining material builds up a sufficient adhesion strength when finally attaching the joining component to the workpiece during manufacture.

From document EP 0 741 842 B1 it is known to apply a hot-melt adhesive to the joining surface of a joining component, in which the joining component is lowered onto the surface of a hot-melt adhesive bath and raised again. After the cooling of the hot-melt adhesive, the joining components are then to be packable and transportable without there being the risk of these sticking together. With regard to this, this document proposes to form a lip on the outer edge of the adhesive surface which is to prevent stress peaks building up in the edge zones of the adhesive layers. As a result of this, the adhesion effect of an adhesively bonded fastening element is also to offer sufficient resistance to lateral force actions upon the stud head and to the pealing effect which is associated therewith.

Document EP 1 456 543 B1 discloses fastening elements which have an adhesive surface which is coated with hot-meltable adhesive. In this document, it is proposed to form an expansion groove in the joining surface radially outside the adhesive, which is to prevent surplus adhesive from protruding over the edge of the adhesive surface and to prevent the adhesive joint having an unsightly appearance during the actual adhesive bonding process.

From document DE 10 2009 042 467 A1, a method for joining a fastening element to a surface section of a component is also known, wherein the fastening element has an adhesive surface onto which is applied a thermally meltable and curable adhesive which is first of all cooled before the transporting of the fastening element, wherein the adhesive is at least partially cured. During the production, the adhesive is then heated to a higher temperature in order to completely cure the adhesive and in order to permanently fasten the fastening element to the desired component or workpiece. The document furthermore proposes to provide small projections on the flange surface which serve as spacer elements in order to realize during the adhesive bonding process a predetermined thickness of the finally produced adhesive layer which is essentially independent of the force with which the fastening element is pressed onto the component.

It has become apparent that joining components, to which adhesives are pre-applied by means of the aforesaid methods, do not adequately withstand the thermally induced stresses and the mechanical stress during the transporting of the joining components as loose material so that in practice an undesirable exfoliation of the adhesive layer from the joining component still frequently takes place during the transporting.

An improved type of connection between joining component and adhesive layer is proposed in document DE 10 2012 021 210 A1. The retention force between joining component and adhesive which is required during the transporting is in this case produced by means of an annular groove which is introduced into the flange of the joining component and covered by the pre-applied adhesive lens. This annular groove leads to a mechanical clamping which especially prevents the losing of the adhesive lens in the event of shear forces acting parallel to the flange surface. Together with the specific adhesion between non-crosslinked adhesive and flange surface which is less pronounced at this point in time, an adequate fixing of the adhesive on the fastening element is thereby achieved. The impressing of the annular groove, which is carried out during the cold forming of the joining component, makes high demands upon the cold forming tool, however, especially in the case of joining components consisting of steel materials with strength grades greater than 4.8. Since the design of the cold forming tool is substantially limited as a result of the geometric demands upon the annular groove for the retention of the adhesive and as a result of the necessary dimensional stability and geometry of the stud flange, the available cold forming tools do not have a satisfactory service life. An adapted metal-cutting manufacturing process for introducing the annular groove is equally uneconomical.

### BRIEF SUMMARY OF THE INVENTION

Given this background, it is an object of the invention to provide an improved joining component with pre-applied joining material and an improved method for its production which preferably avoids at least one of the disadvantages described above. The joining component is especially to be simpler and more cost-effective in manufacture and still be able in the process to effectively prevent exfoliation of the joining material which is pre-applied to the joining component.

This object is achieved according to the invention by means of a joining component of the type referred to in the introductory portion, wherein the application area has a retentive surface structure with elevations forming material undercuts, and wherein the joining material at least partially covers the application area and is introduced into the material undercuts.

The above object is furthermore achieved by means of a method for producing a joining component, comprising the steps of: (i) providing a joining component with a joining surface which has an application area, wherein the application area has a retentive surface structure with elevations forming material undercuts; (ii) applying a heated joining material onto the application area in such a way that the joining material at least partially covers the application area and flows into the material undercuts; (iii) cooling the joining material in such a way that the joining material is captively retained on the application area, the joining component can be transported and the joining material can be activated by means of heat treatment at a later point in time in order to attach the joining component to a workpiece.

The present invention subsequently deals especially with the improvement of the adhesion of a pre-applied joining material, which can be activated by means of heat treatment, to the joining component. This improved adhesion is achieved according to the invention by means of a retentive surface structure, with elevations forming material undercuts, which is provided on the application area of the joining component.

Such a retentive surface structure fulfills essentially the same function as the annular groove in the application area of the joining component proposed in DE 10 2012 021 210 A1. In comparison to an annular groove, such retentive surface structures can be produced more simply, more quickly and more cost-effectively, however. The joining component, in said application area for it, is preferably formed from a metal material.

As a result of the retentive surface structure, a “rough” surface is created, moreover, which leads to the spreading of the applied liquids. This leads to the propagation of the liquid film (joining material) and therefore to flat adhesive lenses. This is generally more favorable.

Retentive surface structures are preferably created by melting of the metal by means of a laser beam, ion beam or electron beam. Such an irradiation of the metal surface leads to a local melting of the joining surface of the joining component on the account of the energy input of the laser beam, ion beam or electron beam. At the same time, some of the material evaporates. The vapor pressure which ensues in the process drives the melt out of the irradiated recess and the melt banks up to form melt protuberances. These melt protuberances, which in the present case are generally referred to as elevations, are frequently also called retentions. Such retentions create material undercuts in the surface structure of the joining surface of the joining component. As a result of such material undercuts or material clearance cuts, semi-open cavities are created and are characterized by material overhangs. Lower-lying layers of the joining surface accordingly form open cavities which are at least partially covered by the banked up melt protuberances in layers of the joining surface lying further above. As a result of this, a clamping (retentive) effect of the application area of the joining surface is created, as a result of which the adhesion of the pre-applied joining material is substantially improved.

Retentive surfaces are basically to differ from commercially available rough surfaces. In contrast to rough surfaces, such retentive surfaces differ not only because of their type of manufacture but essentially differ due to the fact that the elevations (retentions) forming the material undercuts can also absorb forces which are perpendicular to the machined surface (on account of the material undercuts). This especially improves the mechanical adhesion between joining component and pre-applied joining material. The joining material can consequently nest specifically in the material undercuts provided in the application area of the joining surface, that is to say in the retentions. As a result of this, a clamping between the joining component and the pre-applied joining material is created.

Reference may also be made to the fact that the retentive surface structure, which is provided according to the invention, in the application area of the joining surface of the joining component does not serve, or at least not chiefly serve, for the improved connection between the joining component and the workpiece (e.g. body panel) to which it is to be finally attached. The main effect which the present invention exploits by the provision of the retentive surface structure on the joining surface of the joining component is the improved adhesion effect between the joining surface and the joining material which is pre-applied thereto, as a result of which an exfoliation of the joining material during the transporting of the joining component as loose material is effectively prevented.

A joining material which has already been applied to the joining component beforehand and is retained thereon in an essentially positionally true and captive manner is understood in the present case by a pre-applied joining material which can be activated by means of heat treatment. It is therefore preferably a meltable joining material that is to say not a liquid joining material. For example, the pre-applied joining material is an only partially cured, not completely chemically cross-linked, high-viscosity adhesive which by means of heat treatment, e.g. by means of inductive heating, can be fully cured and chemically crosslinked during the final joining process. Alternatively to this, the pre-applied joining material can be an at least partially cured, thermoplastic material which can be (re-) activated by means of heating, e.g. during the welding. Furthermore, it can be a cooled solder material which is pre-applied to the joining surface of the joining component and can be liquefied, that is to say (re-)activated, by means of heating during the soldering.

Overall, by the provision of a retentive surface structure on the joining surface of the joining component, a reliable captive retention for a joining material pre-applied thereto is therefore realized. The retentive surface structure preferably has crown-like formations which at their ends possibly have enlarged diameters or approximately bead-shaped structures, on account of which a form-fitting clamping between the pre-applied joining material and the application area of the joining surface is achieved. This improved adhesion between joining material and joining component withstands not only shear forces in the radial direction of the joining component, that is to say parallel to the joining surface, but also forces which are transverse to the joining surface.

Consequently, the joining components produced in this way are completely suitable as loose material. Also, it is possible to feed such joining components in an automated manner via feed devices from one container to a robot-assisted joining tool without there being the risk of the joining material becoming detached from the joining material in the process.

The aforesaid object is therefore achieved in full.

The blank of the joining component is preferably produced by means of cold forming. The retentive surface structure is then created by melting of the application area of the joining surface in the aforesaid manner with the aid of a laser beam, ion beam of electron beam. After that, the preferably heated joining material in liquid form is applied to the application area so that the joining material at least partially covers the application area and flows into the material undercuts or retentions. After the cooling of the joining material, this is now captively retained on the application area so that the joining material can be transported and (re-)activated by means of heat treatment at a later point in time during the actual attaching of the joining component to a workpiece.

According to a preferred embodiment of the production method according to the invention, the application area of the joining surface is subjected to a radiation-based cleaning during or before the creation of the retentive surface structure, as a result of which organic, crystalline and/or mineral contaminations evaporate.

This process step can be carried out either before the creation of the retentive surface structure or in the same process step. The radiation-based cleaning of the joining surface essentially results in an improvement of the process stability of the adapted joining process of the joining component. The radiation-based cleaning, however, also improves the adhesion of the joining material on the joining surface.

The joining component is preferably a stud which has a shank extending along a central axis and a flange extending transversely thereto. According to a preferred embodiment, the joining surface is arranged on an upper side of the flange facing away from the shank.

In the case of such an adhesive stud, the flange is preferably of plate-like design so that the joining surface on the upper side of the flange is circular. The application area to which the joining material is pre-applied is also preferably of circular design. However, reference may be made to the fact that other geometries of the flange, and therefore also of the joining surface and of the application area, e.g. square or polygonal structures, are also possible.

Alternatively, the joining component, however, can also be another type of connecting element, e.g. a weld stud or a semi-hollow punch rivet. In the case of a semi-hollow punch rivet, which in most cases has a hollow shank and a flange arranged transversely thereto, the application area with the retentive surface structure and the joining material arranged thereon is preferably attached to the outer circumferential surface of the shank of the punch rivet.

In the case of using adhesive as joining material, a wide variety of adhesives which can be pre-applied in the aforesaid manner and can be (re-)activated by means of heat treatment are basically conceivable. For example, single-component or multi-component adhesives or thermoplastic materials can be used.

According to a further embodiment of the joining component according to the invention, a diameter of the application area is of smaller design than a diameter of the joining surface. In this case, it is especially preferred that the diameter of the application area is at least 8 mm, 6 mm or even at least 4 mm smaller than the diameter of the joining surface.

This embodiment is not only a constructional selected dimensioning. This embodiment has essentially the effect that corrosion of the retentive surface structure in the application area is effectively prevented.

It has been proved that retentive surface structures are accompanied by an increase of the corrosion potential. Therefore, a coming-into-contact occurrence of the application area with electrolytes is to be avoided. For this reason, it is preferred to provide the retentive surface only in an inner region of the joining surface which is protected by the joining material against an ingress of moisture. The joining material therefore preferably covers the entire application area in which the retentive surface structure is provided with elevations forming material undercuts. A radial distance of at least 4 mm from the outer edge of the application area to the outer edge of the joining surface or of the flange of the joining component prevents moisture being able to penetrate along the boundary layer between joining material and application area.

According to a further embodiment, the pre-applied joining material has a chemically non-crosslinked or not completely chemically crosslinked adhesive which can be liquefied and chemically crosslinked by means of heat treatment.

The adhesive therefore develops its full adhesion effect only during the joining process. In the state in which it is pre-applied to the joining component (before the joining process, e.g. during the transporting), the adhesive, however, is not full crosslinked and develops only a part of its potential adhesion effect.

According to a further embodiment of the joining component according to the invention, a plurality of dimensionally stable spacer elements, especially consisting of glass, are embedded into the joining material.

These spacer elements are preferably in the main spherical glass elements which are embedded into the joining material, e.g. into the adhesive, and are pre-applied onto the application area of the joining component together with the joining material. Alternatively, the spacer elements can also be other solid materials, which do not necessarily have to be spherical, embedded into the joining material.

The dimensionally stable spacer elements essentially bring along the advantage that as a result of these a gap can be relatively easily established between the joining surface or the application area and the workpiece on which the joining component is finally attached during the joining process. As soon as the joining material is activated or liquefied during the joining process, the dimensionally stable spacer elements are clamped so to speak between the joining surface of the joining component and the workpiece, as a result of which a spaced region is created between joining component and workpiece and in which the joining material can be distributed. The dimensionally stable spacer elements therefore also ensure a good distribution of the joining material during the joining process. In contrast to solutions in which spacer knobs are provided on the joining surface for the aforesaid purpose, such an embedding of the spacer elements into the joining material is of great advantage with regard to production engineering.

According to the aforesaid embodiment, it is especially preferred that the elevations forming the material undercuts project upwards by a retention height with regard to the joining surface, wherein a diameter of the spacer elements is greater than the retention height. In other words, this therefore means that the retentions are preferably smaller than the spacer elements which are embedded into the joining material.

The retentions, which for production-related reasons in most cases have relatively irregular heights, therefore have no influence upon the gap between joining component and workpiece. As a result of this, the stability of the connection which is to be made can in turn be improved as well as ensuring a defined orientation of the joining component on the workpiece.

The diameter of the spacer elements is preferably less than 200 μm and the height of the retentions is less than 60 μm.

For glass beads, which can serve as such spacer elements, a size of between 40 μm and 100 μm, especially preferably in the range of 40 μm to 45 μm, with regard to the diameter has proved to be a practical size. The height of the retentions is usually in the range of 5 μm to 60 μm.

According to a further embodiment, the elevations (retentions) forming the material undercuts are arranged in a grid-like manner in the application area.

For example, the retentions can be attached in the application area in a type of matrix structure or in a rectangular grid. This has the advantage that the retentions are distributed as uniformly as possible over the application area so that the adhesion force, increased by the retentions, between joining material and joining surface acts upon the entire application area as uniformly as possible. Nevertheless, reference may be made to the fact that such retentions, for manufacturing-related reasons, do not create overall a regular overall surface structure but an altogether irregular surface structure.

It is understood that the aforementioned features and the features which are still to be explained below can be applied not only in the respectively disclosed combinations but also in other combinations or on their own without departing from the scope of the present invention.

### BRIEF DESCRIPTION OF THE SEVERAL VIEWS OF THE DRAWINGS

Exemplary embodiments of the invention are represented in the drawings and are explained in more detail in the subsequent description. The drawing is as follows:

FIG. 1 shows a schematic longitudinal sectional view through a joining component according to a first embodiment of the invention with joining material pre-applied thereto.

FIG. 2 shows a perspective schematic view of the joining component according to the FIG. 1 first embodiment of the invention, but without joining material 16.

FIGS. 3A-3C show an enlarged detailed view of an application area of a joining surface of the joining component according to an embodiment of the invention, wherein FIG. 3A shows an enlarged plan view, FIG. 3B shows a perspective detailed view and FIG. 3C shows a sectional view of a part of the application area.

FIG. 4 shows a schematic longitudinal sectional view through a further embodiment of a joining component according to the invention.

### DETAILED DESCRIPTION OF THE PREFERRED EMBODIMENTS

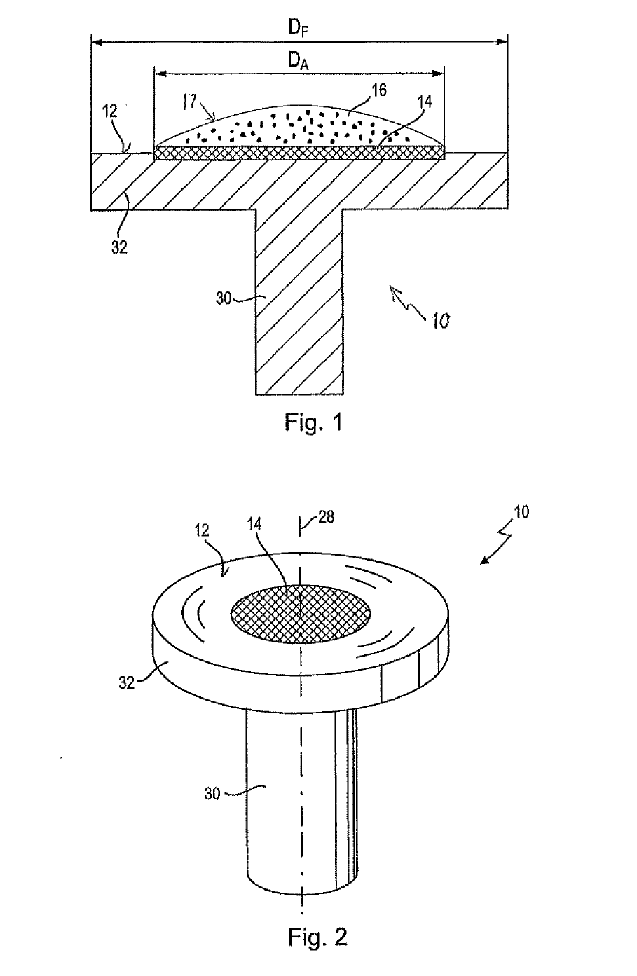

In FIG. 1, a first embodiment of a joining component is shown schematically in longitudinal section. The joining component is collectively identified therein by the reference number 10.

The joining component 10 has a joining surface 12. This joining surface 12 preferably consists of a metal material. A joining material 16 is pre-applied to a section of this joining surface 12, which is in the present case is referred as the application area 14.

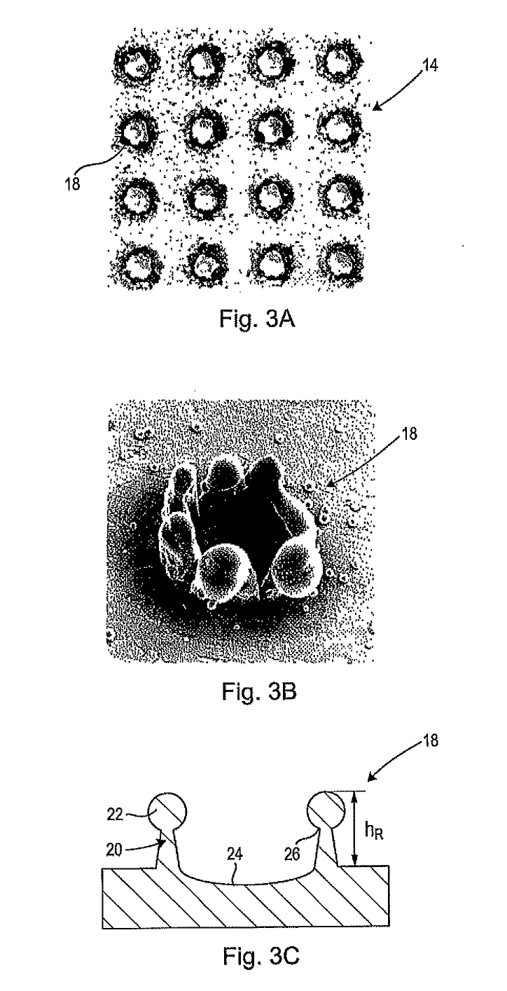

The application area 14 has a retentive surface structure. Details of this retentive surface structure of the application area 14 are shown in FIGS. 3A-3C.

As is especially apparent in FIG. 3A, the retentive surface structure of the application area 14 has a plurality of so-called retentions 18. One of these retentions 18 is shown by way of example in an enlarged detailed view in FIG. 3B.

Such retentions 18 are created by means of irradiation of the application area 14 of the joining surface 12 by means of a laser beam, ion beam or electron beam. Such a laser beam, ion beam or electron beam leads to the material on the surface of the application area 14 melting and to portions of the material banking up towards the top around the impingement point of the beam on account of the evaporation and other processes. As soon as this happens, the laser beam, ion beam or electron beam is interrupted so that the upwardly spurting molten metal solidifies and crown-like formations 20 are created around the laser point, which formations have enlarged diameters or bead-like elements 22 which are shown schematically in a sectional view in FIG. 3C.

This type of crown-like formations 20 are referred to as retentions 18. In the center of the crown-like formations 20, that is to say in the proximity of the impingement point, a type of recess 24 is formed. It is understood that the retentions 18 have irregular structures due to process- or manufacturing-related reasons. The crown-like formations 20 are generally referred to in the present case as elevations 20. The significance of these elevations 20 is that these form material undercuts 26 on account of the bead-like elements 22 which they have at their ends. These material undercuts 26, by means of a type of overhang (bead-like elements 22), form subjacent, semi-open cavities in the application area 14 of the joining surface 12.

The joining material 16 shown in FIG. 1 has been applied in the heated, liquefied state onto the application area 14 and has extended on the application area 14 in a lens-like manner and has solidified in this lens-like form 17 as a result of cooling.

As a result of the structure of the plurality of retentions 18 in the application area 14 with the elevations 20 forming material undercuts 26, a type of clamping between joining material 16 and application area 14 has resulted during the cooling of the joining material 16. On the boundary surface between joining material 16 and application area 14, the joining material 16 has therefore nested itself in the material undercuts 26 in or below the retentions 18. Due to the undercuts 26, the retentions 18 can therefore also absorb forces which are parallel to or perpendicular to the joining surface 12. Therefore, an adequate retention force of the pre-applied joining material 16 is ensured, as a result of which an exfoliation or shearing off of the joining material 16 from the joining surface 12 of the joining component 10 is prevented especially during the transporting.

The joining component 10 can therefore be packaged and transported together with joining material 16 applied thereto as loose bulk material without the joining material 16 lens 17 which is attached on the application area 14 being separated from the joining surface 12 of the joining component 10 during the transporting.

In the case of the embodiment of the joining component 10 according to the invention shown in FIGS. 1 and 2, it is a stud which is preferably designed as an adhesive stud. The pre-applied joining material 16 preferably has according to this embodiment a chemically non-crosslinked or not completely chemically crosslinked adhesive which during the joining process, that is to say during the attaching of the stud 10 to a workpiece, can be liquefied and fully chemically crosslinked by means of heat treatment (e.g. by means of inductive heat treatment). The full retention strength of the adhesive by means of specific adhesion is therefore built up only during the joining process as a result of complete chemical crosslinking of the adhesive. The retentive surface structure of the application area 14 described above, however, already ensures an adequate retention strength before the complete crosslinking of the adhesive, which is sufficient for the transporting of the adhesive stud together with the pre-applied adhesive lens 17.

The stud 10 shown in FIGS. 1 and 2 is preferably of symmetrical or at least in the main symmetrical design. The stud 10 has a shank 30 extending along a central axis 28. This shank 30 is frequently also referred to as the anchor section of the stud 10, since this can serve for the fastening or anchoring of other components. When being used in body construction, pipes are frequently fastened to this shank 30. A male thread can also in principle be provided on the shank 30.

Transversely to the shank 30 or transversely to the central axis 28, the stud 10 has a flange 32. With the aid of this flange 32, the stud 10 is attached or adhesively bonded to the workpiece. The flange 32 is especially of plate-like or cylindrical design and extends essentially in the radial direction around the central axis 28. The joining surface 12 is preferably provided on the upper side of the flange 32 facing away from the shank 30.

The application area 14 already mentioned above forms a section of the joining surface 12. The joining surface 12 as well as the application area 14 are preferably symmetrical around the central axis 28. Especially preferably, the joining surface and application area 14 are in each case are of circular shape and concentric to the central axis 28, as is shown by way of example in FIG. 2.

In FIG. 1, the diameter of the joining surface 12 is designated D_{F} and the diameter of the application area 14 is designated D_{A}. The diameter D_{F} of the joining surface 12 is preferably at least 8 mm larger than the diameter D_{A} of the application area 14. The joining material 16 preferably covers the entire application area 14 over the entire diameter D_{A}. The region of the joining surface 12 remaining free around the application area 14 serves especially for avoiding corrosion of the retentions 18 surface structure in the application area 14. Since the retentions' 18 structuring is accompanied by an increase of corrosion potential, contact with electrolytes is to be avoided. Therefore, it is sufficient to structure the inner application area 14 of the bolt flange 32 which is protected against moisture ingress by the adhesive 16. Consideration is especially to be given in this case to the fact that moisture of several millimeters can penetrate through a crosslinked polymer or along the boundary layer into the adhesion zone. The diameter of the adhesive lens 17 can therefore also be designed to be larger than the diameter D_{A} of the application area 14 so that the adhesive or the joining material 16 covers more than just the application area 14 in which the retentive surface structure is located.

Furthermore, it is preferably to be ensured that the joining surface 12 or the application area 14 is not in contact with the workpiece by the retentions 18 or their upper ends 22 after the joining of the stud 10 with the workpiece. In FIG. 3C, the height of the retentions 18 is generally designated h_{R}. It is understand that this height h_{R} of the retentions is an irregular height depending on the shape since each elevation 20 basically has a slightly different height h_{R}.

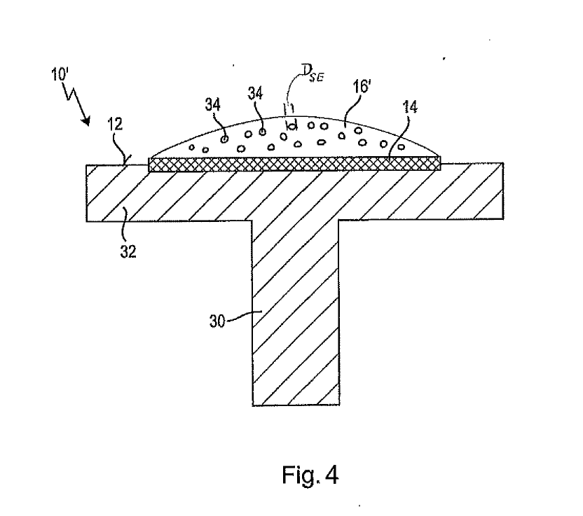

Shown in FIG. 4 is a further embodiment of a joining component 10′ of the aforesaid type which meets the last-named requirements. The joining material 16′ according to this embodiment has a plurality of dimensionally stable spacer elements 34. These spacer elements 34 are preferably spherical elements consisting of glass which are embedded into the joining material 16′.

A diameter D_{SE} of these spacer elements 34 is preferably greater than the maximum height h_{R} of the retentions 18 which are provided in the application area 14. The maximum height h_{R} of the retentions is preferably less than 60 μm. The spacer elements therefore preferably have a diameter D_{SE} which lies within the range of 40 μm to 100 μm. As soon as the joining material 16′ is liquefied during the joining process and after its curing permanently connects the stud 10′ to the workpiece, the gap between the joining surface 12 of the stud 10′ and the workpiece is therefore defined by the spacer elements 34. During the joining process, the spacer elements 34 are distributed preferably uniformly to a greater or lesser extent on the joining surface 12 or on the application area 14 and so set the gap between stud 10 and workpiece.

In conclusion, reference may once more be made to the fact that the joining component 10 or 10′ according to the invention does not necessarily have to be an adhesive stud. Alternatively to this, the aforesaid features can also be applied in the case of a weld stud or a semi-hollow punch rivet. The joining material 16 or 16′, as an alternative to an adhesive, can also feature a thermoplastic material for welding or a fusion solder for soldering. Depending on the component, the joining surface 12 with the joining material 16 or 16′ arranged thereon does not necessarily have to be arranged on the flange of the 10 or 10′ either. In the case of a semi-hollow punch rivet, it would also be conceivable in principle to provide the retentive surface structure, together with the pre-applied joining material 16 applied thereto, on the outer side of the shank.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A joining component comprising:
a joining surface including an application area, and the application area includes a retentive surface structure having a plurality of retentions with elevations and material undercuts beneath a top of the elevations; and
a joining material, activatable by later heat treatment, is located on the application area and is introduced into the material undercuts.

2. A joining component according to claim 1, wherein the joining component is a stud which includes a shank extending along a central axis and a flange radially extending transversely to the shank.

3. A joining component according to claim 2, wherein the joining surface is arranged on an upper side of the flange facing away from the shank.

4. A joining component according to claims 1, wherein a diameter (D_{A}) of the application area is smaller than a diameter (D_{F}) of the joining surface.

5. A joining component according to claim 4, wherein the diameter (D_{A}) of the application area is at least 8 mm smaller than the diameter (D_{F}) of the joining surface.

6. A joining component according to claim 1, wherein the joining material comprises a chemically non-crosslinked or not completely chemically crosslinked adhesive which can be liquefied and chemically crosslinked during the later heat treatment.

7. A joining component according to claim 1, wherein a plurality of dimensionally stable spacer elements, preferably consisting of glass, are distributed in the joining material.

8. A joining component according claim 7, wherein the elevations forming the material undercuts project upwards above the joining surface by a height (h_{R}) of the retentions, and a diameter of the spacer elements (D_{HR}) is larger than the height (h_{R}) of the retentions.

9. A joining component according claim 8, wherein the diameter of the spacer elements (D_{HR}) is less than 200 μm, and the height (h_{R}) of the retentions is less than 60 μm.

10. A joining component according to claim 1, wherein the retentions are arranged in a grid pattern in the application area.

11. A joining component according to claim 1, wherein the elevations forming the material undercuts create an irregular surface structure.

12. A joining component according to claim 1, wherein the joining surface is made of metal and the retentive surface structure is created by melting the metal by means of one of a laser beam, an ion beam or an electron beam.

13. A method for producing a joining component having; a joining surface including an application area, and the application area includes a retentive surface structure having a plurality of retentions with elevations and material undercuts beneath a top of the elevations; and a joining material, activatable by a later heat treatment, is located on the application area and is introduced into the material undercuts; wherein the method comprises the steps of:
providing a joining component with a joining surface which has an application area, and the application area has a retentive surface structure with elevations forming material undercuts;
applying a heated joining material onto the application area so that the joining material is atop the application area and flows into the material undercuts;
cooling the joining material such that the joining material is captively retained on the application area, the joining component can be transported and the joining material can be activated at a later point in time by means of heat treatment in order to attach the joining component to a workpiece.

14. A method according to claim 13, wherein the provision of the joining component further comprises:
producing a blank of the joining component by means of cold forming;
creating the retentive surface structure by melting the application area of the joining surface by means of a laser beam, an ion beam or an electron beam.

15. A method according to claim 14, wherein creating the retentive surface structure further includes:
evaporating contaminants in the application area of the joining surface by means of radiation-based cleaning.
